(19) United States
(12) Patent Application Publication
(10) Pub. No.: US 2019/0369461 A1
(43) Pub. Date: Dec. 5, 2019

(54) BLADE DRIVING DEVICE

(71) Applicant: NIDEC COPAL CORPORATION, Tokyo (JP)

(72) Inventor: Koji SAWANOBORI, Tokyo (JP)

(73) Assignee: NIDEC COPAL CORPORATION, Tokyo (JP)

(21) Appl. No.: 16/469,307

(22) PCT Filed: Nov. 24, 2017
(86) PCT No.: PCT/JP2017/042234

§ 371 Date: Jun. 13, 2019

(30) Foreign Application Priority Data
Dec. 13, 2016 (JP) 2016-241068

(51) Int. Cl. G03B 9/26; G03B 9/14

(52) U.S. Cl. CPC G03B 9/26; G03B 9/14

(57) ABSTRACT

The present invention allows reduction of the thickness of a blade driving device, and, in a mechanism in which a plurality of blade members are interlocked with one another through a lever member, drives the blade members by using sufficient thrust while keeping the operation balance of the lever member and obtaining smooth movement. A blade driving device is provided with a base member; a pair of blade members supported by the base member; a lever member the ends of which are connected to the blade members respectively, and which has, at the center thereof, a bearing part pivotally supported by a rotation shaft provided to the base member; and a linear actuator which causes the lever member to pivot about the rotation shaft, wherein the lever member includes, integrally with the bearing part, a housing part which houses a magnet of the linear actuator.

### CROSS REFERENCE TO RELATED APPLICATIONS

This is a U.S. National Phase Application under 35 U.S.C. § 371 of International Patent Application No. PCT/JP2017/042234, filed Nov. 24, 2017, which claims priority of Japanese Patent Application No. 2016-241068, filed Dec. 13, 2016. The entire contents of which are hereby incorporated by reference.

### FIELD OF TECHNOLOGY

The present invention relates to a blade driving device used in an imaging device, or the like.

### BACKGROUND

Blade driving devices are used to change the state of an opening by driving one or more blade members that advance into the opening, and are used in a variety up optical units, such as camera units, for diaphragms, shutters, diaphragm-shutters, filters, and the like.

As a conventional blade driving device, the electromagnetic driven-type, which uses a magnet and a coil as a driving source, typically is well known, and linear actuators, known as voice coil motors (VCMs) are used in order to reduce the size and thickness.

Moreover, in conventional blade driving devices, those that are provided with mechanisms wherein a plurality of blade members are linked by a lever member that is borne at a center portion are well known, and a structure has been proposed wherein a magnet is installed on the lever member when a linear actuator, as described above, is used as a driving source (referencing Japanese Unexamined Patent Application Publication 2001-281724).

### SUMMARY

With the prior art described above, there is a problem in that the structure is such that, when the magnet of the linear actuator is equipped on the lever member, the magnet is contained within the width of the lever member, making it impossible to use a magnet of an adequately large volume, and thus impossible to produce enough propulsion to drive the blade member smoothly. Moreover, while one may consider provision of a magnet with a large volume that extends beyond the width of the lever member, it would not be possible to attach the magnet stably to the lever member, and thus there would be a problem in that it would not be possible to secure balanced operation of the lever member, nor smooth movement.

Moreover, when the magnet is installed at a place that is away from the rotational center of the lever member, as in the prior art, when a large (heavy) magnet is installed, the moment of inertia when the lever member rotates around the rotary shaft will be large, and thus the overshoot, when controlling the position of the lever member with the linear actuator, will be large. Because of this, there is a problem in that it is difficult to control the position with good responsiveness. In particular, when controlling the size of an aperture, there is a problem in that it is not possible to achieve the desired diaphragm value (AV value or F value) with good sensitivity.

The present invention is proposed in order to handle problems such as these. That is, objects of the present invention are to reduce the thickness of a blade driving device, to enable driving of a blade member with adequate propulsion while achieving smooth movement with balanced operation of the lever member in a mechanism wherein a plurality of blade members are linked by a lever member, and to enable positional control with good responsiveness.

In order to solve such a problem, the lens driving device according to the present invention is provided with the following structures:

A blade driving device, comprising: a base member; a pair of blade members supported on the base member; a lever member, with respective end portions connected to the blade members, wherein the bearing portion, provided in the center, is borne on a rotary shaft that is provided on the base member; and a linear actuator for causing the lever member to rotate around the rotary shaft, wherein: in the lever member, a containing portion, for containing the magnet of the linear actuator, is provided integrally with the bearing portion.

### BRIEF DESCRIPTIONS OF THE DRAWINGS

FIG. 1 is an explanatory diagram depicting the critical portions of a blade driving device according to an example according to the present invention.

FIG. 2 is an explanatory diagram depicting a modified example of an example according to the present invention.

FIG. 3 is an explanatory diagram depicting a modified example of an example according to the present invention.

FIG. 4 is an explanatory diagram depicting a modified example of an example according to the present invention.

FIG. 5 is a perspective assembly diagram of a blade driving device according to an example according to the present invention.

FIG. 6 is an assembly plan view of an example of a blade driving device according to an example according to the present invention.

FIG. 7 is a cross-sectional view, along the section A-A in FIG. 6, of an example of a blade driving device according to an example according to the present invention.

FIG. 8 is a cross-sectional view, along the section B-B in FIG. 6, of an example of a blade driving device according to an example according to the present invention.

FIG. 9 is an interior explanatory diagram of a blade driving device according to an example according to the present invention.

FIG. 10 is an explanatory diagram depicting a camera unit equipped with the blade driving device.

FIG. 11 is an explanatory diagram depicting a mobile electronic device equipped with the blade driving device.

### DETAILED DESCRIPTION

Examples according to the present invention will be explained below in reference to the drawings. Identical reference symbols in the different drawings below indicate positions with identical functions, and redundant explanations in the various drawings are omitted as appropriate.

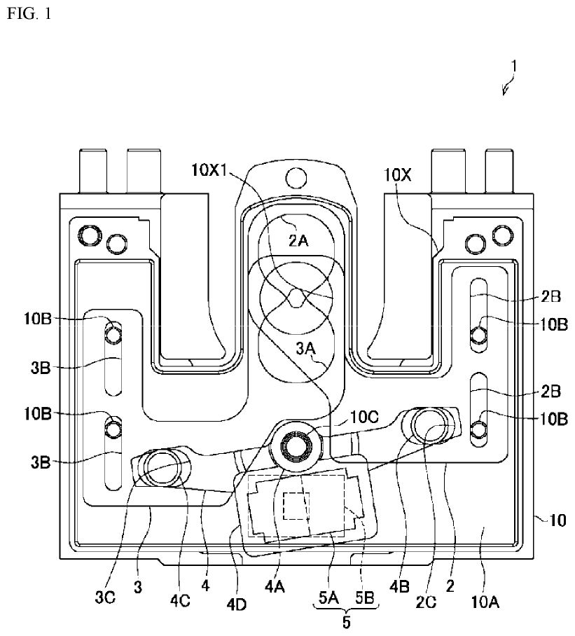

As illustrated in FIG. 1, the blade driving device 1 comprises a base member 10, a pair of blade members 2 and 3, a lever member 4, and a linear actuator 5. The base member 10 comprises a supporting face 10A, and a guiding portion 10B that support the blade members 2 and 3 slidable, and further comprises a rotary shaft 10C that bears the lever member 4 rotatably. In the example in the figure, the base member 10 comprises a blade containing unit 10X that contains the blade members 2 and 3, where the supporting face 10A is provided in the blade containing unit 10X, and the blade containing unit 10X is equipped with an opening 10X1.

The blade members 2 and 3 are provided with openings 2A and 3A, where the area of opening varies depending on the amount of overlap of the openings 2A and 3A, and can move to arbitrary positions from the fully open state to the fully closed state or from the fully closed state to the fully open state. The blade members 2 and 3 are provided with guide holes (elongated holes) 2B and 3B for engaging a guiding portion 10B the base member 10. The guide holes 2B and 3B are provided extending along the direction of movement of the blade members 2 and 3. The shapes of the blade members 2 and 3 are not limited thereto. In a form wherein the base member 10 has an opening and the blade members 2 and 3 advance into this opening, the blade members 2 and 3 have the curved portions, or the like, that define the opening.

The lever member 4 comprises a bearing portion 4A in a center portion thereof, and comprises respective connecting portions 4B and 4C at both end portions thereof. The bearing portion 4A of the lever member 4 is borne on the rotary shaft 10C, where the connecting portion 4B is connected to the connecting hole 2C of the blade member 2, and the connecting portion 4C is connected to the connecting hole 3C of the blade member 3.

A linear actuator 5 comprises a magnet 5A and a coil (flat coil) 5B. The magnet 5A of the linear actuator 5 is attached to the lever member 4, and the coil 5B of the linear actuator 5 is attached to the base member 10. The linear actuator 5 produces a propulsive force through an electric current in the coil 5B, causing the lever member 4 to rotate around the rotary shaft 10C, to cause the pair of blade members 2 and 3 to slide in mutually opposing directions, to adjust the amount of overlap of the openings 2A and 3A.

The lever member 4 comprises a containing portion 4D for containing the magnet 5A. The containing portion 4D is equipped integrally with the bearing portion 4A, where, in the example in the figure, a rectangular containing portion 4D is provided on the side of the bearing portion, and are one side of the rotary shaft 10C.

Such a blade driving device 1, by providing the bearing portion 4A of the lever member 4 integrally with the containing portion 4D for the magnet 5A, makes it possible to hold the magnet with stability, without disrupting the balanced operation of the lever member 4, even when the containing portion 4D is made larger in order to contain a magnet 5A that has a large volume, enabling the lever member 4 to be operated smoothly.

Moreover, even when magnet 5A of a large volume is installed in the containing portion 4D, the magnet 5A, which is a heavy object, can be held in that the vicinity of the rotary shaft 10C, which can keep the moment of inertia small when the lever member 4 rotates around the rotary shaft 10C. This enables control with good responsiveness by keeping the amount of overshoot small when performing positional control of the blade members 2 and 3 through causing the lever member 4 to rotate under servo control of the linear actuator 5.

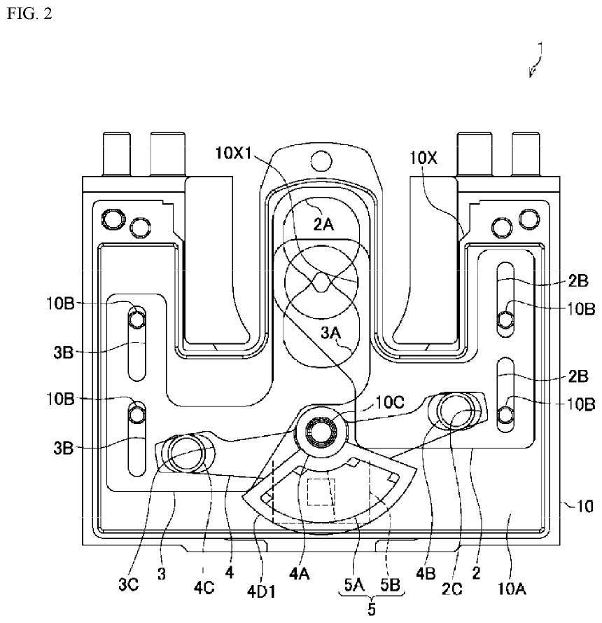

FIG. 2 shows a modified example of the embodiment described above. In this example, the containing portion 4D1 for the magnet 5A, provided on the lever member 4, is shaped like a fan in the plan view. In this way, the containing portion 4D1 is provided integrated with the bearing portion 4A, and the shape thereof being a fan shape that has an outer peripheral edge that is of a constant distance from the axis of the rotary shaft 10C keeps the space that is required for the movement of the containing portion 4D1 within a constant range from the center of the rotary shaft 10C when the lever member 4 rotates around the rotary shaft 10C, making it possible to position the magnet 5A with good spatial efficiency.

Moreover, when producing a large propulsive force through increasing the volume of the magnet 5A, this can keep the moment of inertia of the magnet 5A, of a given volume, small when compared to the case of storing the magnet 5A in a containing portion 4D that is rectangular, as described above. This enables control with good responsiveness by keeping the amount of overshoot even smaller when performing positional control of the blade members 2 and 3 through causing the lever member 4 to rotate under servo control of the linear actuator 5.

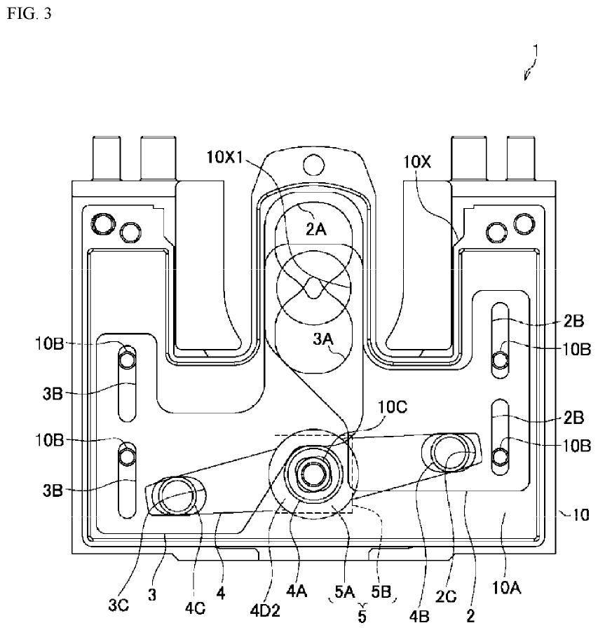

FIG. 3 shows a modified example of the embodiment described above. In this example, the containing portion 4D2 for the magnet 5A that is equipped on the lever member 4 is provided in a ring shape around the bearing portion 4A. In this way, the containing portion 4D2 is provided integrated with the bearing portion 4A, and the shape thereof being a ring shape that is of a constant distance from the axis of the rotary shaft 10C keeps the space that is required for the movement of the containing portion 4D2 within a constant range from the center of the rotary shaft 10C when the lever member 4 rotates around the rotary shaft 10C, making it possible to position the magnet 5A with good spatial efficiency.

Moreover, when producing a large propulsive force through increasing the volume of the magnet 5A when the magnet 5A is held in the containing portion 4D2, this can keep the moment of inertia of the magnet 5A, of a given volume, even smaller when compared to a containing portion 4D that is rectangular or a containing portion 4D1 that is fan-shaped, as described above. This enables control with good responsiveness by keeping the amount of overshoot even smaller when performing positional control of the blade members 2 and 3 through causing the lever member 4 to rotate under servo control of the linear actuator 5.

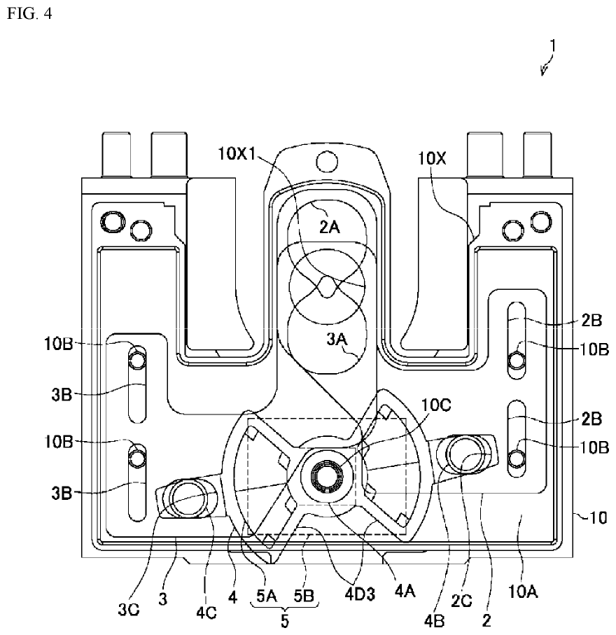

FIG. 4 shows another modified example of the embodiment described above. In this example, the containing portion 4D3 for the magnet 5A that is equipped on the lever member 4 is provided toward the bearing portion 4A side, and on both sides of the rotary shaft 10C, where the containing portion 4D3 is provided integrated with the bearing portion 4A. This is also able to produce the same effects as in the embodiments described above. While, in the example in the figure, both containing portions 4D3 are fan-shaped, there is no limitation thereto, and instead, for example, the two containing portions 4D3 may each individually, or together, be rectangular.

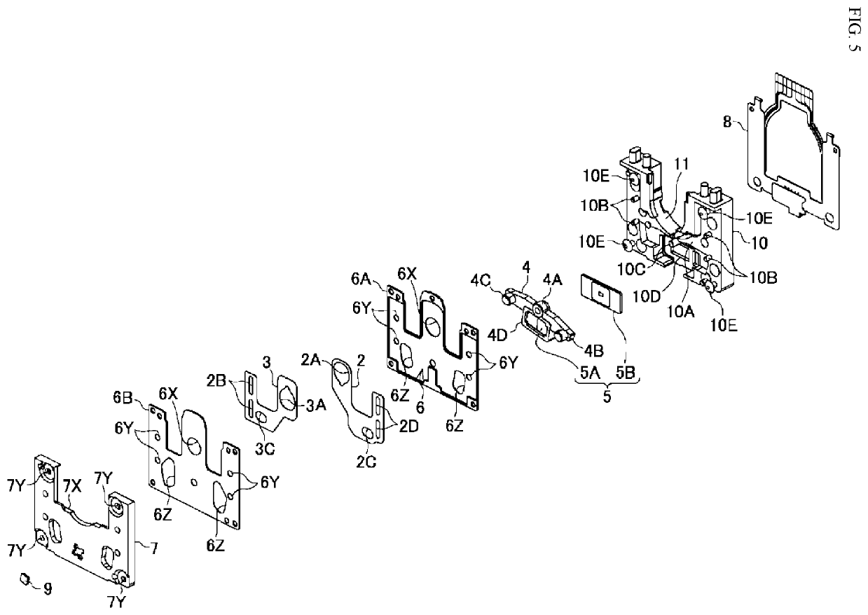

A more specific embodiment will be explained below. FIG. 5 is an exploded perspective diagram of a blade driving device 1 that is a diaphragm device. This blade driving device 1 comprises a base member 10, blade members 2 and 3, a lever member 4, and a linear actuator 5 (a magnet 5A and a coil (flat coil) 5B), as described above, and, additionally, comprises blade supporting units 6A and 6B that form a blade chamber 6 for containing the blade members 2 and 3 therein, a cover member 7, and a circuit board 8.

In the example in the figure, the base member 10 is provided with a lens frame containing portion 11, which is recessed into a U-shape, at the outer peripheral edge. The base member 10, as described above, comprises: a supporting face 10A, a guiding portion 10B, and a rotary shaft 10C, and also a coil supporting portion 10D for supporting the coil 5B, a bonding part 10E for bonding the base member 10 and the cover member 7, and so forth.

The blade supporting units 6A and 6B are plate-shaped members for forming a blade chamber 6 for containing the thin blade members 2 and 3, where the opening 6X is provided at a position that corresponds to the openings 2A and 3A of the blade members 2 and 3. Moreover, the blade supporting units 6A and 6B are provided with holes 6Y into which the guiding portion 10B of the base member 10 is inserted, and also with holes 6Z in the range of movement of the connecting portions 4B and 4C of the lever member 4, corresponding to the connecting holes 2C and 3C of the blade members 2 and 3.

The cover member 7 comprises a recessed portion 7X corresponding to the lens frame containing portion 11 of the base member 10, and a bonding part 7Y, for bonding to the bonding part 10E of the base member 10. A yoke 9, for positioning the magnet 5A, is attached to the cover member 7.

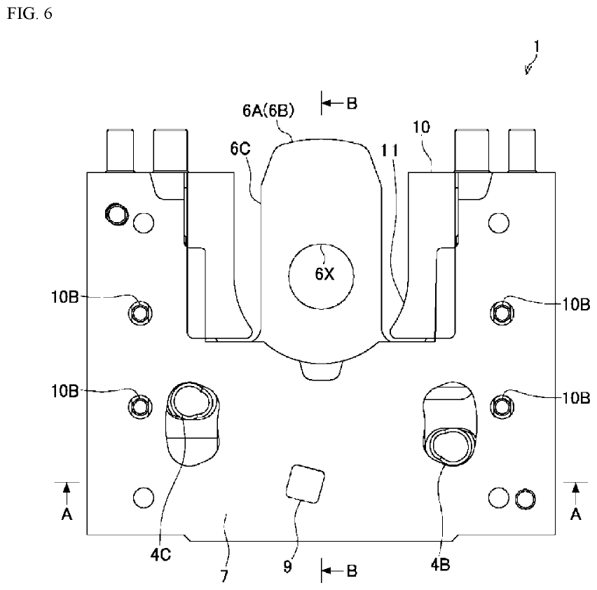

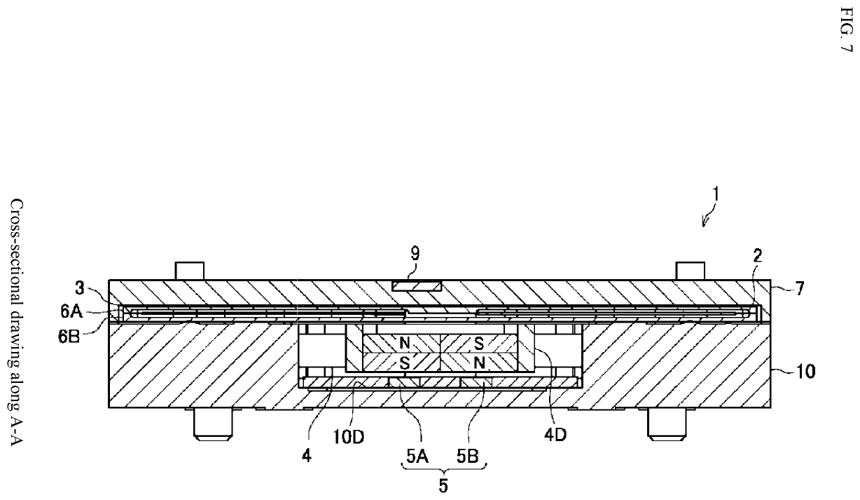

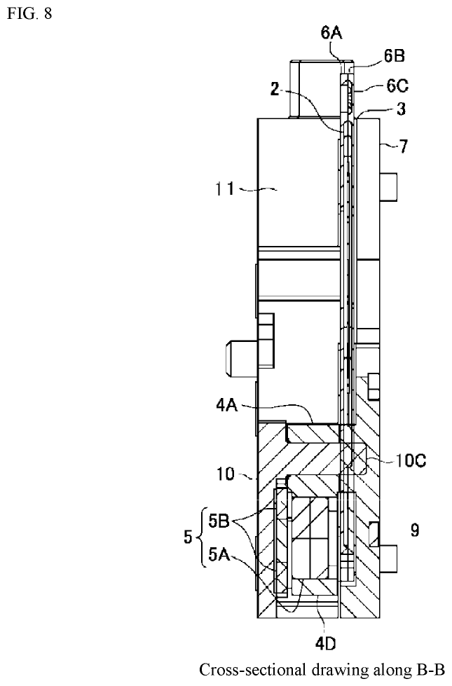

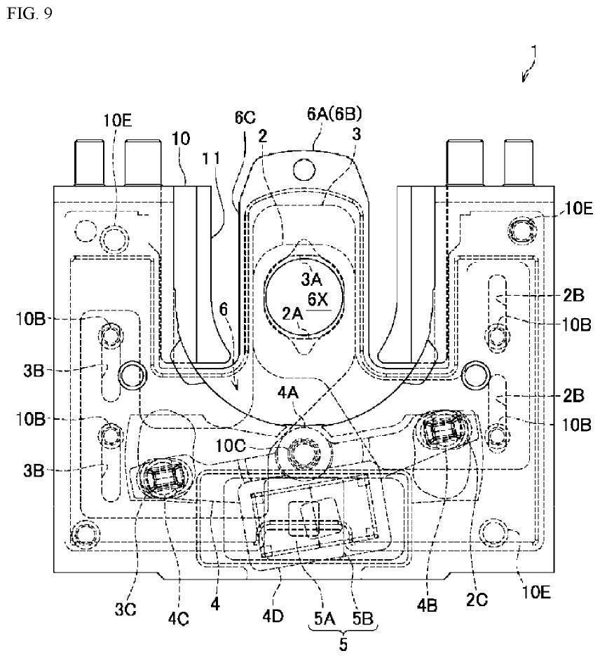

FIG. 6 through FIG. 9 depict states in the assembly of the blade driving device 1. The blade supporting units 6A and 6B, for enclosing the blade members 2 and 3, are equipped with a protruding portion 6C, wherein an opening 6X is formed, so that the opening 6X will be positioned within the lens frame containing portion 11 of the base member 10. In the blade driving device 1, through the lens frame, not shown, being contained within the lens frame containing portion 11, the protruding portion 6C, which has an opening 6X, will be positioned within the lens frame.

The magnet 5A, which is contained in the containing portion 4D of the lever member 4, is magnetized toward the left and the right of the rotary shaft 10C, and magnetized in the direction of thickness of the base member 10. Additionally, the coil 5B is positioned so as to be perpendicular to the lines of magnetic force of the magnet 5A, to structure a linear actuator 5 for causing the lever member 4 to rotate around the rotary shaft 10C.

When the linear actuator 5 is driven to cause the lever member 4 to rotate, the blade members 2 and 3 that are connected to the connecting portions 4B and 4C of the lever member 4 will move along the protruding portions 6C of the blade supporting units 6A and 6B, to adjust the area of opening within the openings 6X through the state of overlap of the openings 2A and 3A of the blade members 2 and 3 and the openings 6X of the blade supporting units 6A and 6B.

Note that the yoke 9 is disposed on the cover member 7 so as to face the vicinity of the magnet 5A, to hold the non-powered position of the lever member 4 in a position wherein the magnet 5A is attracted to the yoke 9.

With such a blade driving device 1, the magnet 5A of the linear actuator 5 is contained in a containing portion 4D that is integrated with the bearing portion 4A of the lever member 4, thus enabling installation on the lever member 4 in a stabilized state, even when the magnet 5A is provided with a large volume. Through this, this enables the blade members 2 and 3 to be moved with a high propulsive force, while the magnet 5A is installed in a stabilized state.

Moreover, the magnet 5A that is equipped on the lever member 4 being positioned in the vicinity of the rotary shaft 10C makes it possible to keep the moment of inertia relatively small, even when the weight of the magnet 5A is large. This enables highly responsive control through suppressing overshoot when rotating the lever member 4, through positional control by the linear actuator 5, to position the blade members 2 and 3 at an arbitrary position between the fully open position in the fully closed position. This enables, for example, diaphragm control with high sensitivity.

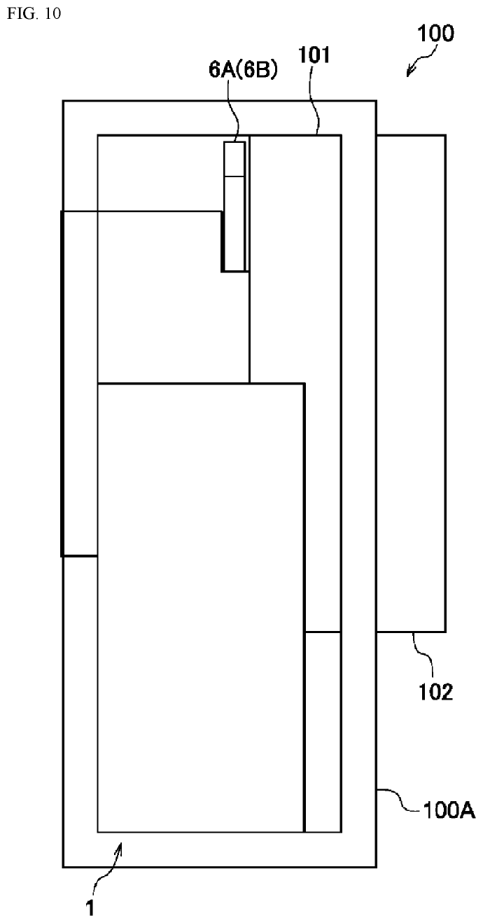

FIG. 10 depicts a camera unit 100 as an optical unit that is provided with the blade driving device 1. The blade driving device 1 may be assembled together with the lens frame 101 as described above, and may be mounted in a case 100A wherein an imaging element 102 is mounted, to structure a camera unit 100. Moreover, various types of optical units can be produced through assembling the blade driving device 1 together with other optical components. Such a camera unit 100 or optical unit can be made thinner, enabling a reduction in the thickness of the space for installation along the optical axial direction. Moreover, because the blade driving device 1 can be assembled and integrated after the adjustments to the lens frame 101, and the like, have been completed, this enables simple and highly accurate adjustments, and enables simple mounting through integration of the blade driving device 1. Moreover, this enables the diaphragm value to be adjusted with high sensitivity.

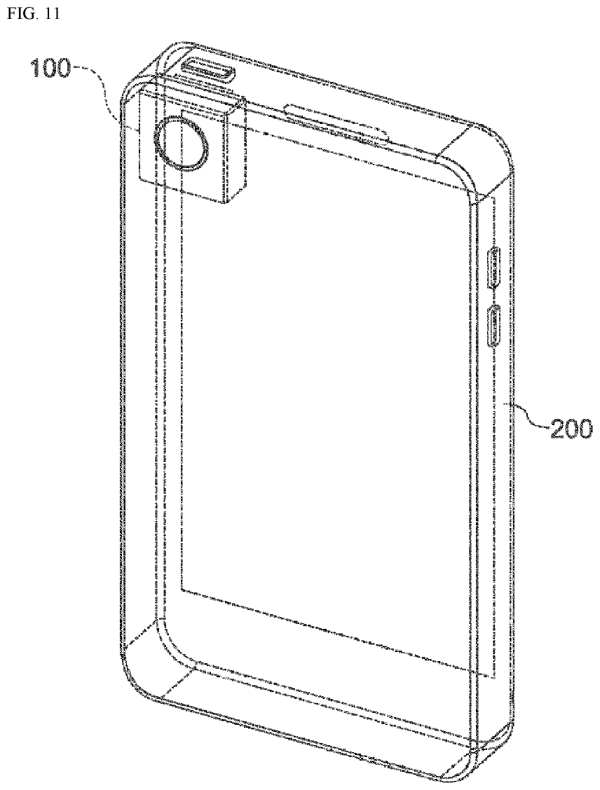

FIG. 11 depicts a mobile electronic device (mobile information terminal) 200 that is equipped with the camera unit 100 described above. The mobile electronic device 200, such as a smart phone, or the like, has severe limitations on the thickness of the units packaged in the interior thereof, but the camera unit 100, as described above, enables a reduction in thickness through assembly with the blade driving device 1 contained within the thickness of the lens frame 101, thus enabling packaging with excellent spatial efficiency in a mobile electronic device 200 that targets high portability and design characteristics. Note that the members disposed within the frame 3 in these examples have the layout positions and shapes designed so as to be assembled sequentially from one side of the base member 10.

While embodiments according to the present invention were described in detail above, referencing the drawings, the specific structures thereof are not limited to these embodiments, but rather design variations within a range that does not deviate from the spirit and intent of the present invention are also included in the present invention. Moreover, insofar as there are no particular contradictions or problems in purposes or structures, or the like, the technologies of the various embodiments described above may be used together in combination.

1. A blade driving device, comprising:
a base member;
a pair of blade members supported on the base member;
a lever member, with respective end portions connected to the blade members, comprising a bearing portion in the center, and is borne on a rotary shaft that is provided on the base member; and
a linear actuator causing the lever member to rotate around the rotary shaft, wherein the lever member comprises a containing portion containing the magnet of the linear actuator and provided integrally with the bearing portion.

2. The blade driving device as set forth in claim 1, wherein:
the containing portion is provided in a ring shape on the periphery of the bearing portion.

3. The blade driving device as set forth in claim 1, wherein:
the containing portion is provided to the side of the bearing portion, and on one side of the rotary shaft.

4. The blade driving device as set forth in claim 1, wherein:
the containing portion is provided to the side of the bearing portion, and on both sides of the rotary shaft.

5. The blade driving device as set forth in claim 3, wherein:
the containing portion is of a fan shape in the plan view.

6. A camera unit comprising a blade driving device as set forth in claim 1.

7. A mobile electronic device comprising a camera unit as set forth in claim 6.

8. The blade driving device as set forth in claim 4, wherein the containing portion is of a fan shape in the plan view.
